(19) United States
(12) Patent Application Publication
(10) Pub. No.: US 2026/0339184 A1
(43) Pub. Date: Oct. 29, 2026

(54) ILLUMINATION SYSTEM AND PROJECTION APPARATUS

(71) Applicant: Coretronic Corporation, Hsin-Chu (TW)

(72) Inventors: Chin-Wen Huang, Hsin-Chu (TW); Pin-Jui Huang, Hsin-Chu (TW)

(73) Assignee: Coretronic Corporation, Hsin-Chu (TW)

(21) Appl. No.: 19/635,814

(22) Filed: Apr. 1, 2026

Related U.S. Application Data
(60) Provisional application No. 63/796,396, filed on Apr. 29, 2025.

(30) Foreign Application Priority Data
Jul. 14, 2025 (CN) 202510964280.6

(51) Int. Cl. G03B 21/20

(52) U.S. Cl. CPC G03B 21/204; G03B 21/2013; G03B 21/206; G03B 21/2066

(57) ABSTRACT

An illumination system includes a first laser module, a first wavelength conversion element, a second laser module, a second wavelength conversion element, and a light guide component. The first laser module emits a first laser beam. The first wavelength conversion element includes a first wavelength conversion region and a non-wavelength conversion region. The first wavelength conversion region converts the first laser beam into first wavelength-converted beam. The second laser module emits a second laser beam. The second wavelength conversion element includes a second wavelength conversion region. The second wavelength conversion region converts second laser beam into second wavelength-converted beam. When an interface between the first wavelength conversion region and the non-wavelength conversion region is disposed on predetermined path of the first laser beam, the first laser module is in turned-off state, and the second laser module is in turned-on state. A projection apparatus is also provided.

### CROSS-REFERENCE TO RELATED APPLICATION

This application claims the priority benefit of U.S. provisional application serial no. 63/796,396, filed on Apr. 29, 2025, and China application serial no. 202510964280.6, filed on Jul. 14, 2025. The entirety of each of the above-mentioned patent applications is hereby incorporated by reference herein and made a part of this specification.

### BACKGROUND

### Technical Field

The disclosure relates to an optical system and apparatus, and particularly relates to an illumination system and a projection apparatus.

### Related Art

With the development of projection technology, users have increasingly higher demands for the image quality of projectors. Some projection apparatuses adopt laser light sources combined with phosphor wheels (wavelength conversion wheels) as a source of illumination beams. However, in projection apparatuses using timing-sequential rotating phosphor wheels, due to the slower response speed of the phosphor wheels, color breaking (color breakup) phenomena usually occur. That is, when the rotation speed of the phosphor wheel is slower, the frequency of color switching per unit time is lower, causing the human eye to perceive rainbow artifacts. However, if the rotation speed of the phosphor wheel is increased to address the color breaking problem, then the noise generated by the phosphor wheel and the driving motor thereof becomes excessive.

The light source of laser projectors is mainly formed by red, green, and blue lasers. Due to their characteristics of high color purity and ability to achieve high color gamut coverage, they are gradually entering the mainstream projector market. However, due to the high coherence characteristics of laser light sources, laser speckle frequently appears on the images of laser projectors.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system and a projection apparatus that may effectively suppress color breaking and laser speckle phenomena and achieve good optical effects.

Other purposes and advantages of the disclosure may be further understood from the technical features disclosed by the disclosure.

To achieve one or part or all of the above purposes or other purposes, an embodiment of the disclosure provides an illumination system including a first laser module, a first wavelength conversion element, a second laser module, a second wavelength conversion element, and a light guide component. The first laser module is configured to emit a first laser beam, and the first wavelength conversion element includes at least one first wavelength conversion region and at least one non-wavelength conversion region. The at least one first wavelength conversion region and the at least one non-wavelength conversion region are sequentially disposed on a light path of the first laser beam, and the at least one first wavelength conversion region is configured to convert the first laser beam into a first wavelength-converted beam. The second laser module is configured to emit a second laser beam, and the second wavelength conversion element includes a second wavelength conversion region. The second wavelength conversion region is disposed on a light path of the second laser beam, and the second wavelength conversion region is configured to convert the second laser beam into a second wavelength-converted beam. When an interface between the at least one first wavelength conversion region and the at least one non-wavelength conversion region of the first wavelength conversion element is disposed on a predetermined light path of the first laser beam, the first laser module is in a turned-off state, and the second laser module is in a turned-on state. The light guide component is disposed on light paths of the first wavelength-converted beam from the first wavelength conversion element and the second wavelength-converted beam from the second wavelength conversion element, and the light guide component is configured to filter (selectively reflects/transmits) the first wavelength-converted beam to provide a first colored light, and filter (selectively reflects/transmits) the second wavelength-converted beam to provide a second colored light.

To achieve one or part or all of the above purposes or other purposes, an embodiment of the disclosure provides a projection apparatus including the aforementioned illumination system, a light valve, and a projection lens. The light valve is disposed on a light path of an illumination beam and is configured to convert the illumination beam into an image beam, in which the illumination beam includes at least one of the first colored light, the second colored light, and the first laser beam. The projection lens is disposed on a light path of the image beam and is configured to project the image beam out of the projection apparatus.

Based on the above, the illumination system and the projection apparatus of the embodiments of the disclosure have at least one of advantages as follows. In the embodiments of the disclosure, when an interface between at least one first wavelength conversion region and at least one non-wavelength conversion region of the first wavelength conversion element is disposed on a predetermined light path of the first laser beam, the first laser module is in a turned-off state, and the second laser module is in a turned-on state. In this way, the configuration may prevent the first laser beam from irradiating the interface and generating unstable mixed-colored light. Instead, at this time, the second laser beam provided by the second laser module forms the second colored light by means of the second wavelength conversion element and the light guide component, so that the light valve at this time may be turned on and receive the second colored light. Therefore, by controlling the switching of the laser modules, to increase the switching frequency of the colored light beam received by the light valve per unit time, the illumination system and the projection apparatus of the embodiments of the disclosure may achieve high brightness and good image quality, and may effectively suppress laser speckle phenomenon with the combination of the laser modules and wavelength conversion element.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIGS. 1A, 1B, 1C, and 1D and are light path diagrams illustrating an illumination system of an embodiment of the disclosure when a first laser beam, a first colored light, a second colored light, and a third colored light are transmitted to a light homogenizing component, respectively.

FIG. 2 is a schematic diagram of a projection apparatus of an embodiment of the disclosure.

FIG. 3 is a timing diagram of light beams of the projection apparatus in FIG. 2.

FIG. 4 shows a spectrum of the first laser beam and a second laser beam, a spectrum of a third laser beam, a reflectance spectrum of a first dichroic mirror, and a reflectance spectrum of a second dichroic mirror in FIGS. 1A-1D.

FIGS. 5A, 5B, and 5C are front view diagrams of three variation embodiments of the first wavelength conversion element in FIG. 1A.

FIG. 6 is a timing diagram of light beams of the projection apparatus adopting the first wavelength conversion element in FIG. 5A.

FIGS. 7A and 7B are front view diagrams of another two variation embodiments of the first wavelength conversion element and the second wavelength conversion element in FIG. 1A.

FIG. 7C is a light path diagram of the illumination system of another embodiment of the disclosure.

FIGS. 8A, 8B, 8C, and 8D are light path diagrams of the illumination system of another embodiment of the disclosure when the first laser beam, the first colored light, the second colored light, and the third colored light are transmitted to the light homogenizing component, respectively.

FIG. 9 is a timing diagram of the projection apparatus adopting the illumination system in FIGS. 8A-8D.

FIG. 10 is a light path diagram of the illumination system of yet another embodiment of the disclosure.

FIG. 11 is a light path diagram of the illumination system of still another embodiment of the disclosure.

FIG. 12 is a timing diagram of light beams of the projection apparatus adopting the illumination system in FIG. 11.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

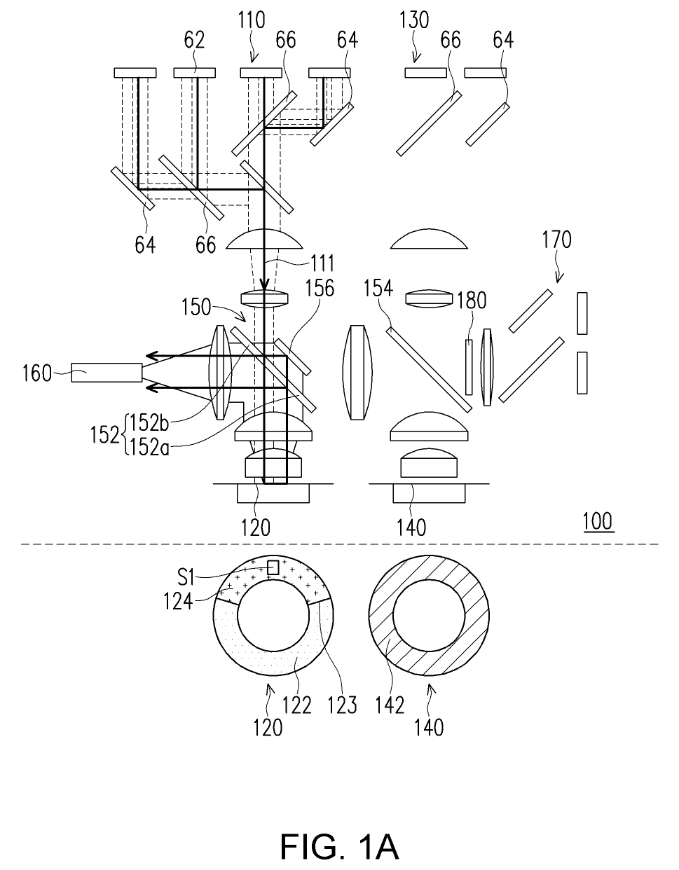

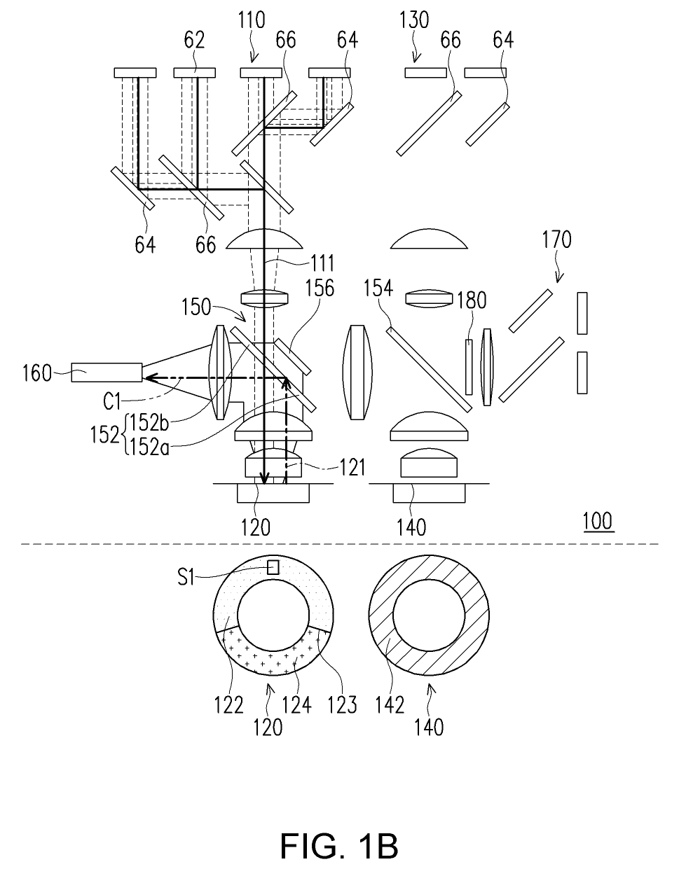

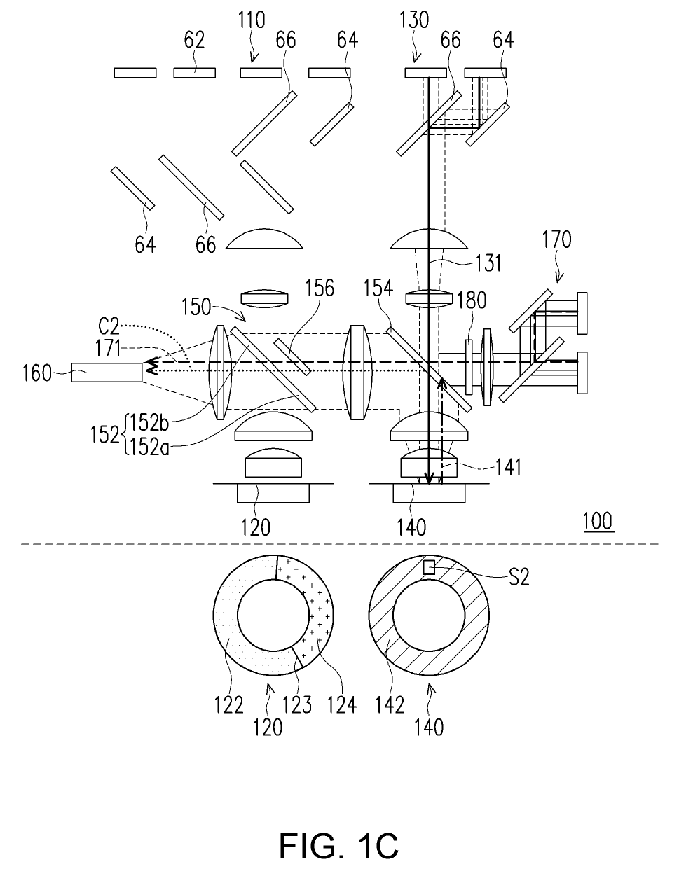

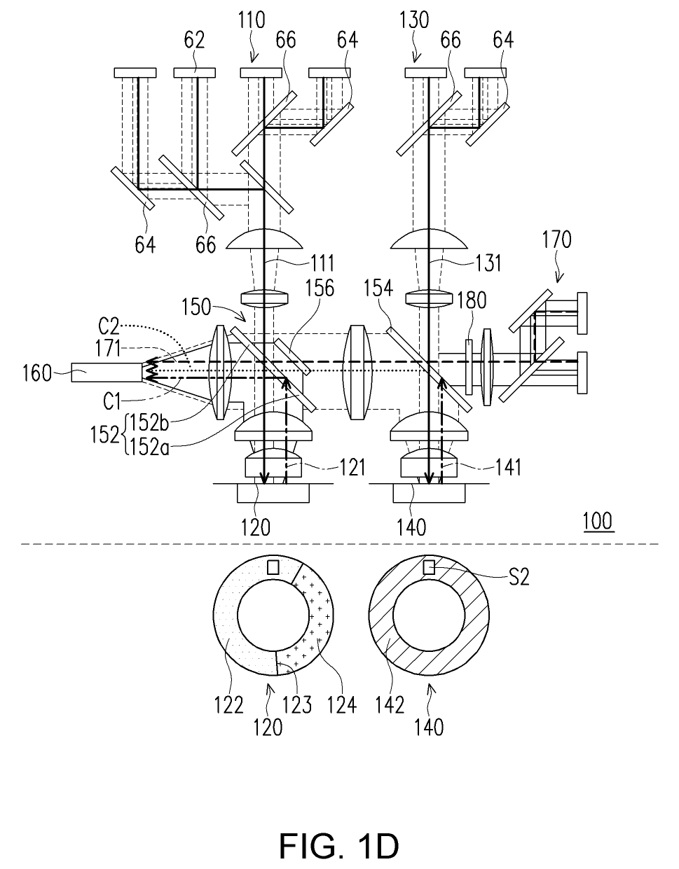

FIGS. 1A, 1B, 1C, and 1D are light path diagrams illustrating an illumination system of an embodiment of the disclosure when a first laser beam, a first colored light, a second colored light, and a third colored light are transmitted to a light homogenizing component, respectively. Referring to FIGS. 1A-1D, an illumination system 100 of this embodiment includes a first laser module 110, a first wavelength conversion element 120, a second laser module 130, a second wavelength conversion element 140, and a light guide assembly 150. The first laser module 110 is configured to emit a first laser beam 111 (shown in FIGS. 1A, 1B, and 1D), and the first wavelength conversion element 120 includes at least one first wavelength conversion region 122 and at least one non-wavelength conversion region 124.

The at least one first wavelength conversion region 122 and the at least one non-wavelength conversion region 124 are sequentially disposed on the light path of the first laser beam 111, and the first wavelength conversion element 120 is not disposed on the light path of the second laser beam 131. The at least one first wavelength conversion region 122 is configured to convert the first laser beam 111 into a first wavelength-converted beam 121. The second laser module 130 is configured to emit a second laser beam 131 (shown in FIG. 1C), the second wavelength conversion element 140 includes a second wavelength conversion region 142, the second wavelength conversion region 142 is disposed on the light path of the second laser beam 131, and the second wavelength conversion element 140 is not disposed on the light path of the first laser beam 111. The second wavelength conversion region 142 is configured to convert the second laser beam 131 into a second wavelength-converted beam 141. The two annular structures at the bottom of FIGS. 1A-1D schematically illustrate front view diagrams of the first wavelength conversion element 120 and the second wavelength conversion element 140, respectively. The first wavelength conversion region 122 and the non-wavelength conversion region 124 of the first wavelength conversion element 120 are arranged in an annular distribution, for example, and the second wavelength conversion region 142 of the second wavelength conversion element 140 is arranged in an annular pattern, for example. The position of a light spot S1 where the first laser beam 111 is incident on the first wavelength conversion element 120 and the position of a light spot S2 where the second laser beam 131 emitted by the second laser module 130 is incident on the second wavelength conversion element 140 are schematically illustrated.

The first wavelength conversion element 120 is, for example, a wavelength conversion wheel configured to rotate, so that the first wavelength conversion region 122 and the non-wavelength conversion region 124 alternately enter the light path of the first laser beam 111. In this embodiment, the second wavelength conversion element 140 is also, for example, a wavelength conversion wheel configured to rotate, and the second laser beam 131 may be incident on the second wavelength conversion region 142. In this embodiment, as shown in FIG. 1C, when an interface 123 between the at least one first wavelength conversion region 122 and the at least one non-wavelength conversion region 124 of the first wavelength conversion element 120 is disposed on a predetermined light path of the first laser beam 111, the first laser module 110 is in a turned-off state and the second laser module 130 is in a turned-on state. In one embodiment, when a portion of the first wavelength conversion region 122, the interface 123, and a portion of the non-wavelength conversion region 124 are disposed on the predetermined light path of the first laser beam 111, the first laser module 110 is in a turned-off state, and the second laser module 130 is in a turned-on state. The portion of the first wavelength conversion region 122 is a portion of the first wavelength conversion region 122 adjacent to the interface 123, and the portion of the non-wavelength conversion region 124 is a portion of the non-wavelength conversion region 124 adjacent to the interface 123.

The light guide component 150 is disposed on the light paths of the first wavelength-converted beam 121 from the first wavelength conversion element 120 and the second wavelength-converted beam 141 from the second wavelength conversion element 140. The light guide component 150 is configured to filter the first wavelength-converted beam 121 to provide a first colored light C1 (a wavelength band of the first wavelength-converted beam 121 includes a wavelength band of the first colored light C1), and to filter the second wavelength-converted beam 141 to provide a second colored light C2 (a wavelength band of the second wavelength-converted beam 141 includes a wavelength band of the second colored light C2). In this embodiment, the first laser beam 111 and the second laser beam 131 are, for example, blue laser beams, the first colored light C1 is, for example, a green light beam, and the second colored light C2 is, for example, a red light beam. The first wavelength conversion region 122 is, for example, a region coated with green or yellow phosphor, and the first wavelength-converted beam 121 is, for example, a yellow light beam or a green light beam with a broader wavelength band, while the light guide component 150 filters the first wavelength-converted beam 121 to provide a purer (narrower wavelength band) green light beam. The second wavelength conversion region 142 is, for example, a region coated with yellow or red phosphor, and the second wavelength-converted beam 141 is, for example, a yellow light beam or a red light beam with a broader wavelength band, while the light guide component 150 filters the second wavelength-converted beam 141 to provide a red light beam or a red light beam with a narrower wavelength band.

In this embodiment, the light guide component 150 may be configured as an optical assembly. The light guide component 150 includes a first dichroic mirror 152 and a second dichroic mirror 154. The first dichroic mirror 152 is disposed between the first laser module 110 and the first wavelength conversion element 120 and is configured to reflect a portion of the first wavelength-converted beam 121 to filter the first wavelength-converted beam 121 to provide the first colored light C1. The second dichroic mirror 154 is disposed between the second laser module 130 and the second wavelength conversion element 140 and is configured to reflect a portion of the second wavelength-converted beam 141 to filter the second wavelength-converted beam 141 to provide the second colored light C2.

In this embodiment, the light guide component 150 further includes a third dichroic mirror 156 disposed between the first dichroic mirror 152 and the first laser module 110, and also disposed between the first dichroic mirror 152 and the second dichroic mirror 154.

In one embodiment, the first wavelength conversion element 120 may be, for example, a reflective phosphor wheel, and the non-wavelength conversion region 124 of the first wavelength conversion element 120 is configured to reflect the first laser beam 111 to the first dichroic mirror 152. Alternatively, in another embodiment, the first wavelength conversion element 120 may be, for example, a transmissive phosphor wheel, and the non-wavelength conversion region 124 is configured to allow the first laser beam 111 to pass through (be transmitted through) and be transmitted along a light path to the first dichroic mirror 152 by a light-guiding element (such as a reflective mirror). The first dichroic mirror 152 is configured to allow the second colored light C2 from the second dichroic mirror 154 to pass through.

In this embodiment, a portion of the first laser beam 111 is reflected by the first dichroic mirror 152, and another portion of the first laser beam 111 is transmitted through the first dichroic mirror 152 and is then reflected by the third dichroic mirror 156. The first dichroic mirror 152 may be divided into a first part 152a and a second part 152b. The second part 152b is configured to allow the first laser beam 111 from the first laser module 110 to transmit through and reflect the first wavelength-converted beam 121. The first part 152a is configured to reflect the first wavelength-converted beam 121, allow a part (for example, half) of the first laser beam 111 from the non-wavelength conversion region 124 to transmit through, and reflect another part (for example, the other half) of the first laser beam 111 from the non-wavelength conversion region 124.

In this embodiment, the illumination system 100 further includes a light homogenizing component 160, disposed on the light path of the first colored light C1 reflected by the first dichroic mirror 152, disposed on the light path of the second colored light C2 reflected by the second dichroic mirror 154 and then transmitted through the first dichroic mirror 152, and disposed on the light path of the first laser beam 111 reflected by the first dichroic mirror 152 and the third dichroic mirror 156. The light homogenizing component 160 is, for example, a light integrator rod or a lens array, configured to homogenize the light beam.

In one embodiment, the illumination system 100 further includes a third laser module 170, configured to provide a third laser beam 171, and the light guide component 150 is disposed on the light path of the third laser beam 171. The color of the third laser beam 171 corresponds to the color of the first colored light C1 or the color of the second colored light C2, which may effectively enhance the light intensity of the color of the first colored light C1 or the second colored light C2. In FIGS. 1A-1D, the third laser beam 171 is exemplified as a red laser. In this embodiment, the third laser beam 171 emitted by the third laser module 170 sequentially is transmitted through the second dichroic mirror 154, the third dichroic mirror 156, and the first dichroic mirror 152 and is transmitted to the light homogenizing component 160.

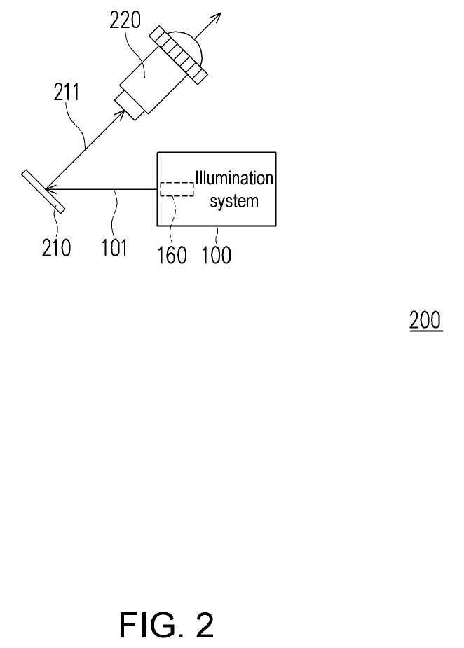

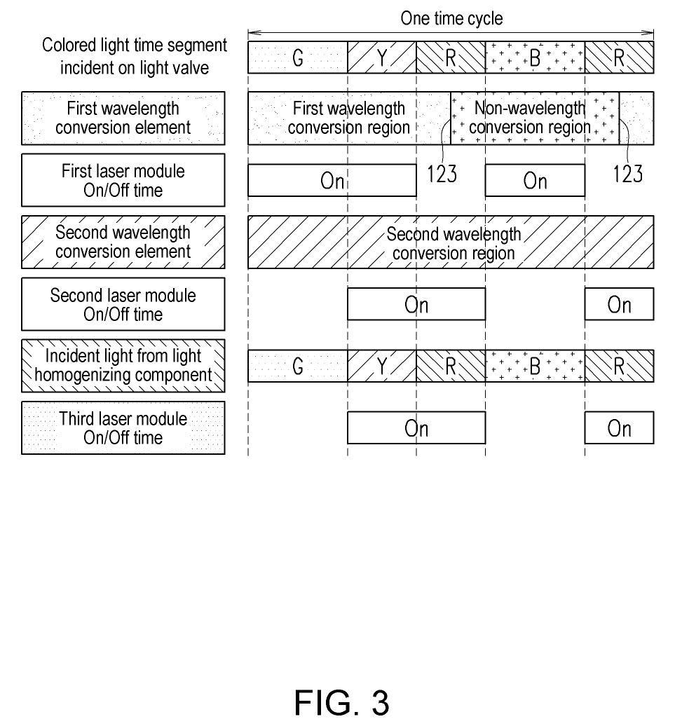

FIG. 2 is a schematic diagram of a projection apparatus of an embodiment of the disclosure, and FIG. 3 is a timing diagram of light beams of the projection apparatus in FIG. 2. Referring to FIGS. 1A-1D, 2, and 3, a projection apparatus 200 of this embodiment includes the aforementioned illumination system 100, a light valve 210, and a projection lens 220. The light valve 210 is disposed on the light path of the illumination beam 101 and is configured to convert the illumination beam 101 into an image beam 211. The illumination beam 101 includes at least one of the first colored light C1, the second colored light C2, and the first laser beam 111. That is, the first colored light C1, the second colored light C2, and the first laser beam 111 enter the light homogenizing component 160 in multiple time segments, and after being homogenized by the light homogenizing component 160, exit from the light homogenizing component 160 as the illumination beam 101 transmitted toward the light valve 210. The projection lens 220 is disposed on the light path of the image beam 211 and is configured to project the image beam 211 out of the projection apparatus 200, for example, to project onto a screen or various forms of imaging surfaces to form a projection image. In this embodiment, the first colored light C1 and the second colored light C2 filtered by the first dichroic mirror 152 and the second dichroic mirror 154 have higher color purity, which may enhance the color purity of green chromaticity point or red chromaticity point of the projection image.

In this embodiment, the light valve 210 is, for example, a digital micro-mirror device (DMD), a liquid-crystal-on-silicon panel (LCOS panel), or other suitable spatial light modulator, which may modulate the illumination beam 101 into the image beam 211. The projection lens 220 includes, for example, a combination of one or more optical lens elements having refractive power, such as various combinations of non-planar lens elements including a biconcave lens element, a biconvex lens element, a concave-convex lens element, a convex-concave lens element, a plano-convex lens element, and a plano-concave lens element. In one embodiment, the projection lens 220 may further include an optical reflective element to project the image beam 211 from the light valve 210 to a projection target in a reflective manner. The embodiments of the disclosure do not limit the configuration and types of the projection lens 220.

In this embodiment, as illustrated in FIG. 1D, when a portion of the first wavelength conversion region 122 is disposed on the light path of the first laser beam 111 emitted by the first laser module 110, both the first laser module 110 and the second laser module 130 are in a turned-on state, so that the first colored light C1 and the second colored light C2 from the light guide component 150 are superposed to form a third colored light. In this embodiment, the third colored light is, for example, a yellow light beam.

In this embodiment, within one time cycle (for example, within the time for the first wavelength conversion element 120 to rotate 360 degrees), the first colored light C1, the third colored light, the second colored light C2, the first laser beam 111, and the second colored light C2 from the light guide component 150 are sequentially transmitted to the light homogenizing component 160, which may refer to the timing diagram in FIG. 3. In this embodiment, the first colored light C1 is a green light beam, represented by "G" in the timing diagram, the third colored light is a yellow light beam, represented by "Y" in the timing diagram, the second colored light C2 is a red light beam, represented by "R" in the timing diagram, and the first laser beam 111 is a blue light beam, represented by "B" in the timing diagram.

The timing of the G time segment in FIG. 3 corresponds to the state in FIG. 1B, where the first laser module 110 is turned on, the first laser beam 111 is incident on the first wavelength conversion region 122, and the second laser module 130 is turned off.

The timing of the Y time segment in FIG. 3 corresponds to the state in FIG. 1D, where both the first laser module 110 and the second laser module 130 are turned on, and the first laser beam 111 and the second laser beam 131 are respectively incident on the first wavelength conversion region 122 and the second wavelength conversion region 142. In one embodiment, the third laser module 170 may be turned on in synchronization with the Y time segment.

The timing of the R time segment in FIG. 3 corresponds to FIG. 1A, where as the first wavelength conversion element 120 rotates, the interface 123 between the first wavelength conversion region 122 and the non-wavelength conversion region 124 enters the predetermined light path of the first laser beam 111. The R time segment corresponds to, for example, when a portion of the first wavelength conversion region 122, the interface 123, and a portion of the non-wavelength conversion region 124 are disposed on the predetermined light path of the first laser beam 111, and at this time, in order to avoid unstable mixed-colored light from entering the light valve 210, this embodiment adopts the method of turning off the first laser module 110 to avoid this problem. At this time, the second laser module 130 remains in the turned-on state to allow the second colored light C2 to be incident on the light valve 210, so the light valve 210 does not need to be turned off at this time and may continue to convert the illumination beam 101 into the image beam 211 thereby avoiding a loss of brightness. Therefore, the illumination system 100 and the projection apparatus 200 of this embodiment may achieve high brightness. In one embodiment, the emission period of the third laser beam 171 may be in synchronization with the R time segment, that is, the third laser beam 171 may be emitted during at least one of the R time segments and the Y time segment. In embodiments that adopt the third laser beam 171 as a light source, the emission period of the third laser beam 171 at least partially overlaps with the turned-on period of the second laser module 130, and FIG. 3 takes as an example that the emission period of the third laser beam 171 completely coincides (overlaps) with the turned-on period of the second laser module 130.

The B time segment in FIG. 3 corresponds to FIG. 1C, where the first laser module 110 is turned on and the first laser beam 111 is incident on the non-wavelength conversion region 124.

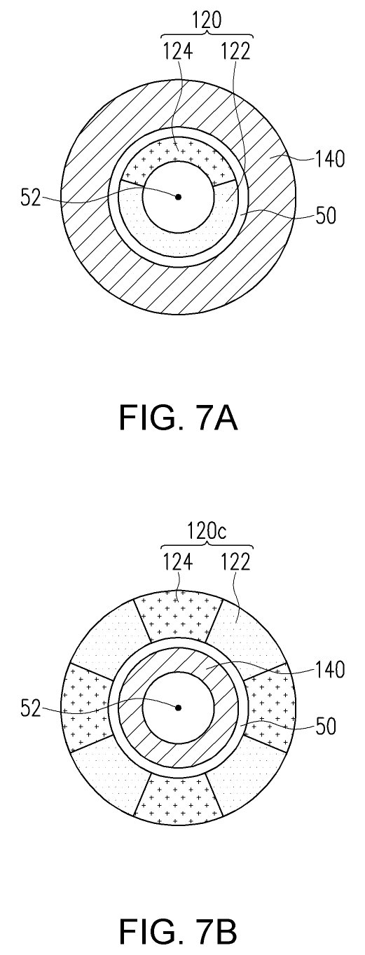

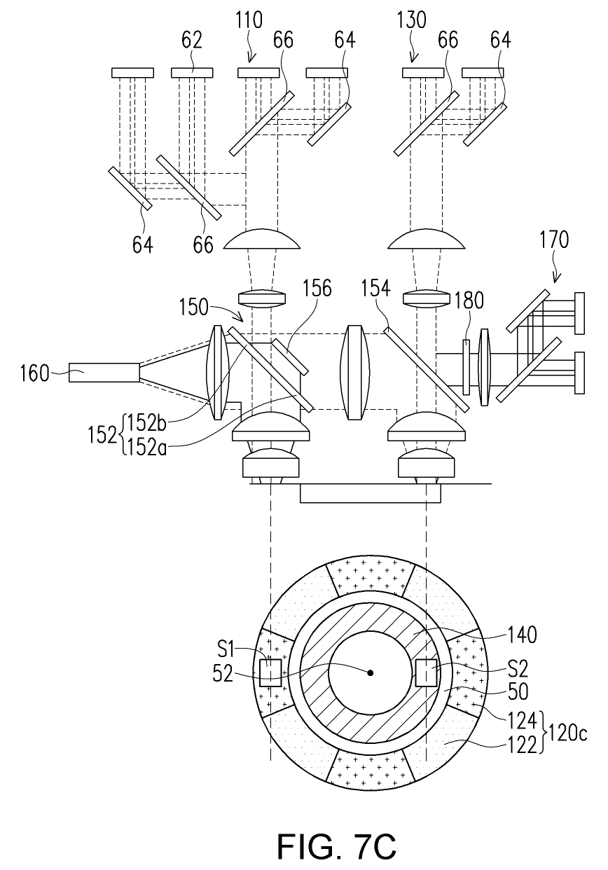

This embodiment uses the first laser module 110 and the first wavelength conversion element 120 to correspond to one of the R time segment and the G time segment (FIG. 3 takes the G time segment as an example) and the B time segment, where the first laser module 110 is turned on during the G time segment and the B time segment; by configuring the second laser module 130 and the second wavelength conversion element 140 to correspond to the other one of the R time segment and the G time segment (FIG. 7 takes the R time segment as an example), the second laser module 130 corresponding to the R time segment (or G time segment) is turned at a transition period (switching interval) between the G time segment and the B time segment (or the transition period between the R time segment and the B time segment). By maintaining the second laser module 130 in a turned-on state during the first colored light segment (e.g., R-segment) or the transition periods, the illumination system 100 maintains a predetermined light output power during specific color switching processes. This compensates for the brightness loss caused by the deactivation of the first laser module 110, thereby achieving the technical effect of high brightness for the overall illumination system.

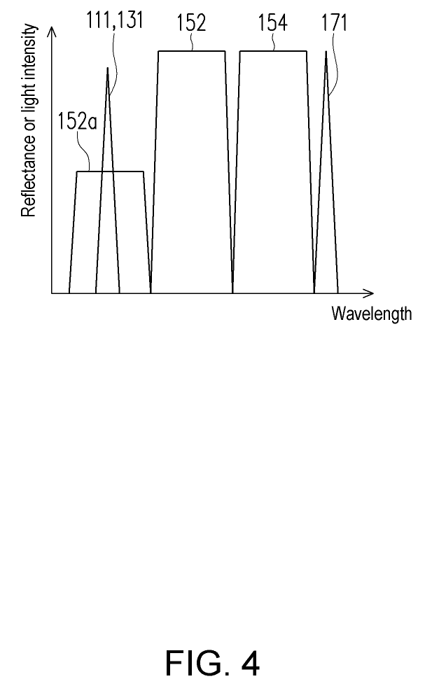

FIG. 4 shows the spectrum of the first laser beam 111 and the second laser beam 131, the spectrum of the third laser beam 171, the reflectance spectrum of the first part 152a of the first dichroic mirror 152, the reflectance spectrum of the first dichroic mirror 152 (the first part 152a and the second part 152b), and the reflectance spectrum of the second dichroic mirror 154 in FIGS. 1A-1D. In this embodiment, the transmittance of the third laser beam 171 through the light guide component 150 is greater than or equal to 90%. The spectral overlap area of the first colored light C1 and the second colored light C2 is less than 15% of the spectral area of the first colored light C1 or the second colored light C2. In FIG. 4, the spectra of the first laser beam 111 and the second laser beam 131 are shown as the same for example. However, in other embodiments, the spectra of the two laser beams may also be different. In this embodiment, the second part 152b of the first dichroic mirror 152 is configured to reflect light beams (such as the first colored light C1) in a wavelength range from 491 nanometers to 582 nanometers and transmit light beams in other wavelengths; the first part 152a of the first dichroic mirror 152 is configured to reflect light beams (such as the first colored light C1) in a wavelength range from 491 nanometers to 582 nanometers, transmit a part (for example, 50%) of light beams (such as the first laser beam 111) in a wavelength range from 435 nanometers to 485 nanometers, and reflect another part (for example, another 50%) of light beams in a wavelength range from 435 nanometers to 485 nanometers, and transmit light beams in other wavelengths; the second dichroic mirror 154 is configured to reflect light beams (such as the second colored light C2) in a wavelength range from 583 nanometers to 636 nanometers. The main wavelength of the third laser beam 171 is at least greater than or equal to 636 nanometers, that is, greater than or equal to the maximum wavelength of the light beam that may be reflected by the second dichroic mirror 152.

In this embodiment, the illumination system 100 further includes a diffusion component 180, disposed on the light path of the third laser beam 171, and located between the third laser module 170 and the light guide component 150. In this embodiment, the third laser beam 171 is, for example, a laser light, and the diffusion component 180 may suppress the speckle phenomenon generated by the third laser beam 171. In this embodiment, the diffusion component 180 is, for example, a static element (such as a diffusion sheet) or a movable element (such as a diffusion wheel), both of which have the effect of suppressing speckles. In other embodiments, the illumination system 100 may also not adopt the third laser module 170 and the diffusion component 180.

In this embodiment, the optical characteristic (emission spectrum) of the first wavelength conversion region 122 of the first wavelength conversion element 120 is different from the optical characteristic (emission spectrum) of the second wavelength conversion region 142 of the second wavelength conversion element 140. The spectral overlap area of the first wavelength-converted beam 121 and the second wavelength-converted beam 141 may, for example, be less than or equal to 15% of the spectrum area of the first wavelength-converted beam 121 or the second wavelength-converted beam 141. For example, in this embodiment, the first wavelength conversion region 122 has green phosphor, and the second wavelength conversion region 142 has yellow phosphor. In other embodiments, the optical characteristic (emission spectrum) of the first wavelength conversion region 122 of the first wavelength conversion element 120 is the same as the optical characteristic (emission spectrum) of the second wavelength conversion region 142 of the second wavelength conversion element 140, for example, the first wavelength conversion region 122 and the second wavelength conversion region 142 both have yellow phosphor. In this embodiment, the second wavelength conversion element 120 is a movable element, for example, a rotatable phosphor wheel. In other embodiments, the second wavelength conversion element 120 may also be a static element, for example, a phosphor component. The rotation speeds of the first wavelength conversion element 120 and the second wavelength conversion element 140 may be the same or different. In the illumination system 100 of this embodiment, the laser speckle phenomenon may be effectively suppressed by generating the first wavelength-converted beam 121 and the second wavelength-converted beam 141 by means of the first wavelength conversion element 120 and the second wavelength conversion element 140.

In this embodiment, the first laser module 110, the second laser module 130, and the third laser module 170 may each include a plurality of laser diodes 62, a plurality of reflective mirrors 64, and a plurality of beam combining components 66. The beam combining components 66 and the reflective mirrors 64 may combine the light emitted by the plurality of laser diodes 62 into a composite laser beam, for example, the first laser beam 111, the second laser beam 131, or the third laser beam 171. In this way, the overall size of the light path may be minimized by shifting or bending the light paths of the first laser module 110, the second laser module 130, and the third laser module 170.

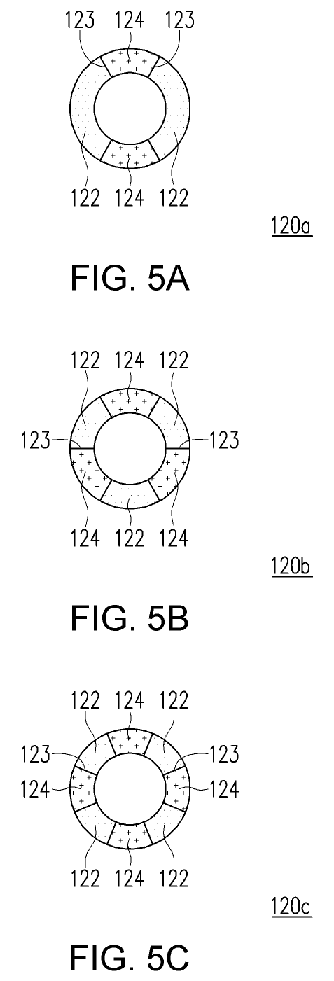

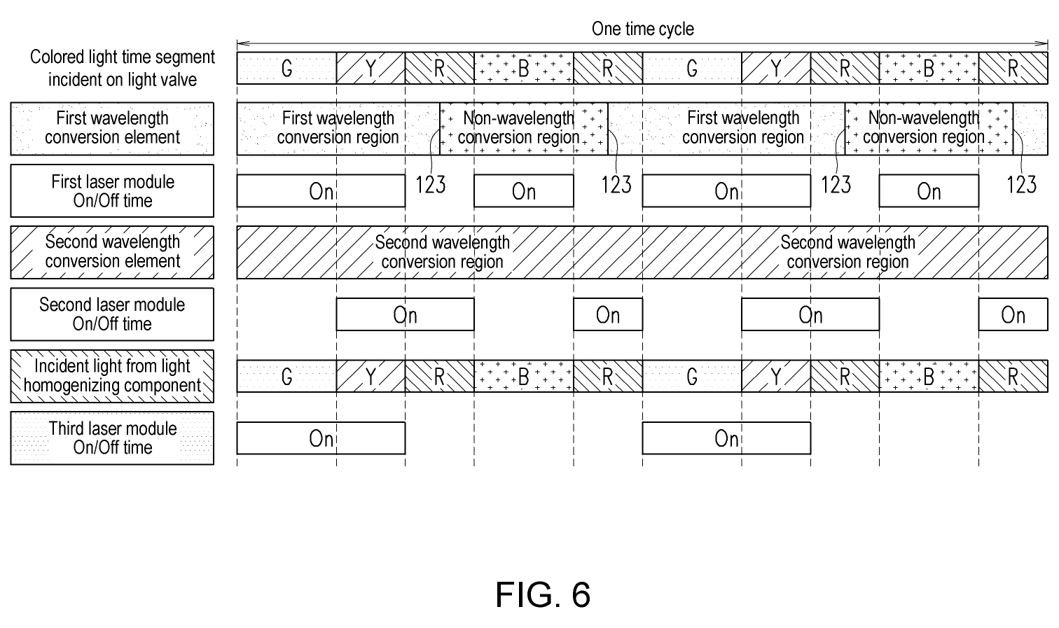

FIGS. 5A, 5B, and 5C are front view diagrams of three variation embodiments of the first wavelength conversion element in FIG. 1A. Referring to FIGS. 5A, 5B, and 5C, in these three embodiments, the first wavelength conversion elements 120a, 120b, 120c each have a plurality of first wavelength conversion regions 122 and a plurality of non-wavelength conversion regions 124 disposed in an alternating arrangement, and there are interfaces 123 between adjacent first wavelength conversion regions 122 and non-wavelength conversion regions 124. Taking the first wavelength conversion element 120a as an example, the timing schematic diagram applicable thereto is illustrated in FIG. 6, which, compared with the timing schematic diagram in FIG. 3, provides twice the number of the G, Y, R, B, R time segments within the range of 360-degree rotation (per 360-degree rotation) of the first wavelength conversion element 120a. In another embodiment, the Y time segment may also be omitted, and the sequence may be the G, Y, R, B, R, G, R, B, R time segments. In the embodiments in FIGS. 5A-5C, when the rotation speed of the first wavelength conversion elements 120a, 120b, 120c is not changed, since twice or more the number of the G, Y, R, B, R time segments are provided within the range of 360-degree rotation, the illumination system may achieve a higher color update rate and may effectively suppress color breaking (color breakup) artifacts. In addition, since this configuration may not require increasing the rotation speed of the first wavelength conversion elements 120a, 120b, 120c, the problem of excessive motor noise may be effectively avoided.

FIGS. 7A and 7B are front view diagrams of another two variation embodiments of the first wavelength conversion element and the second wavelength conversion element in FIG. 1A. Referring to FIG. 7A, the first wavelength conversion element 120 and the second wavelength conversion element 140 are located on a same rotating substrate 50, and the radial distance of the first wavelength conversion element 120 to a central axis 52 of the rotating substrate 50 is not equal to the radial distance of the second wavelength conversion element 140 to the central axis 52 of the rotating substrate 50. In FIG. 7A, the radial distance of the first wavelength conversion element 120 to the central axis 52 of the rotating substrate 50 is smaller than the radial distance of the second wavelength conversion element 140 to the central axis 52 of the rotating substrate 50. In FIG. 7B, the radial distance of the first wavelength conversion element 120c to the central axis 52 of the rotating substrate 50 is greater than or equal to the radial distance of the second wavelength conversion element 140 to the central axis 52 of the rotating substrate 50. The first wavelength conversion element 120 and the second wavelength conversion element 140 may be arranged as concentric circles. The first wavelength conversion element 120c and the second wavelength conversion element 140 and the rotating substrate 50 in FIG. 7B may be applied in an illumination system as shown in FIG. 7C, and in FIG. 7C, the light spot S1 incident on the first wavelength conversion element 120c and the light spot S2 incident on the second wavelength conversion element 140 are respectively positioned on opposite sides of the rotating substrate 50, and on a reference plane of the rotating substrate 50, the central axis 52 is located between the light spot S1 and the light spot S2.

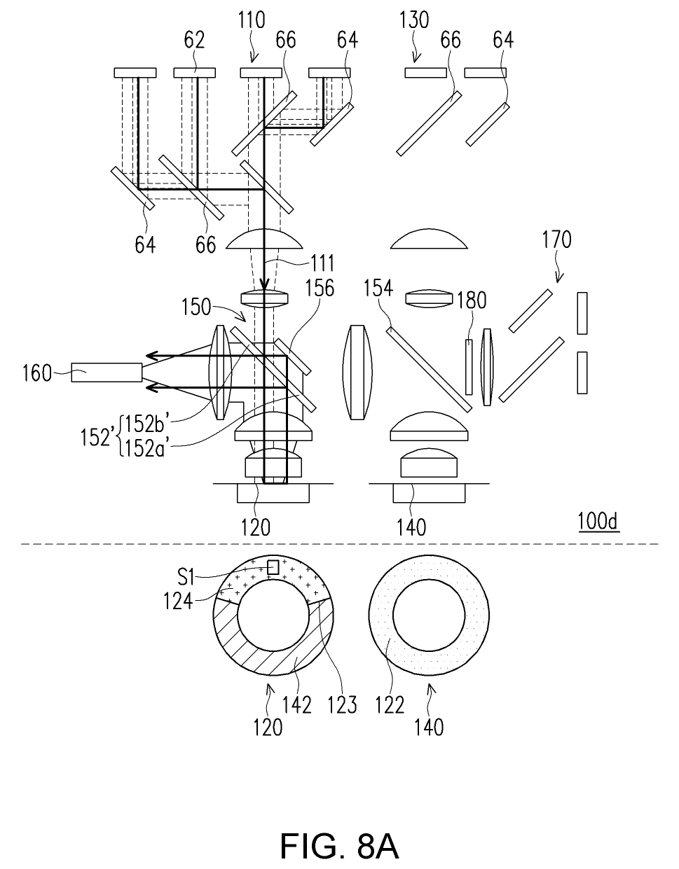

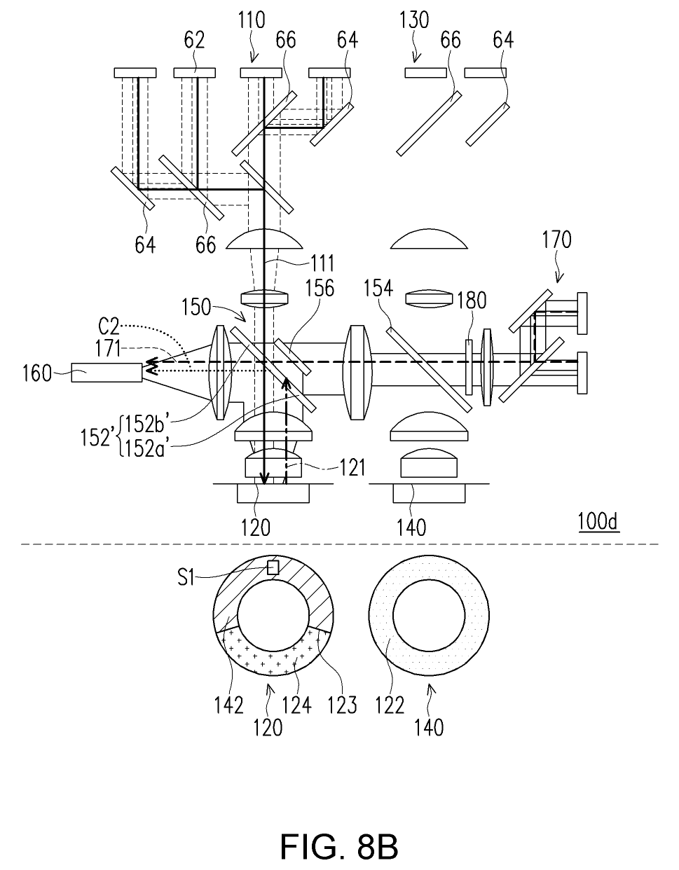

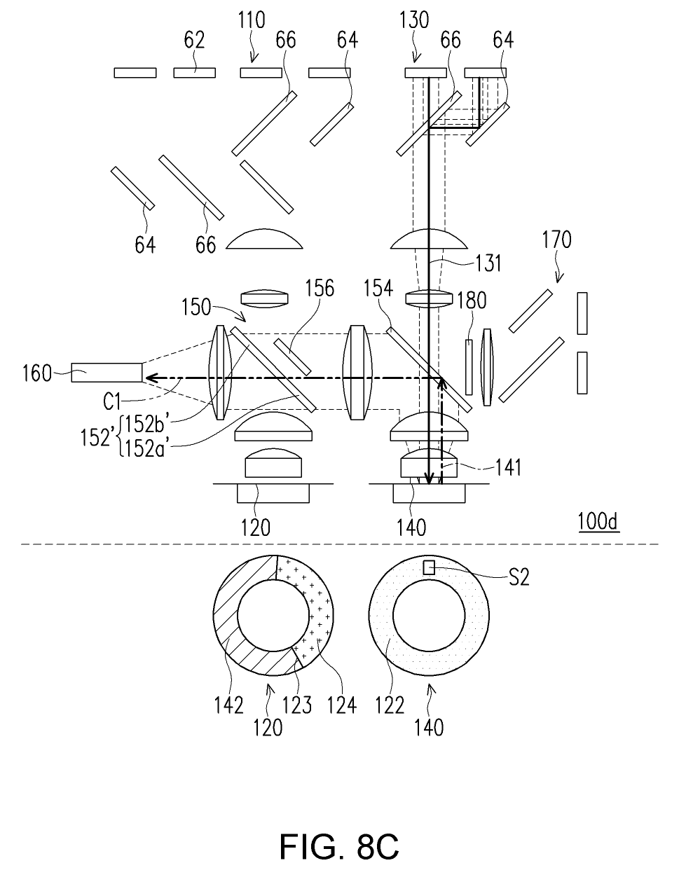

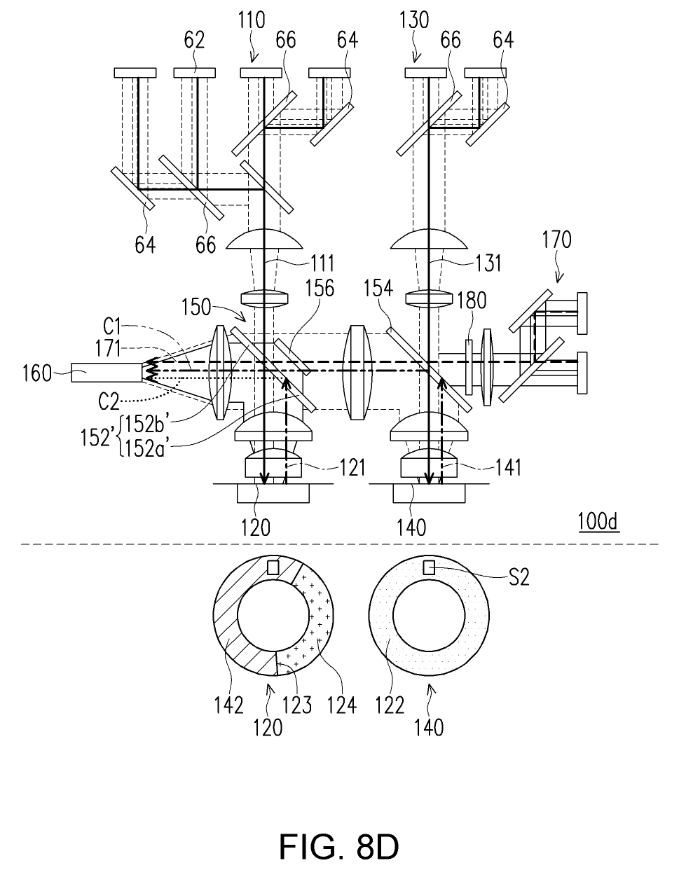

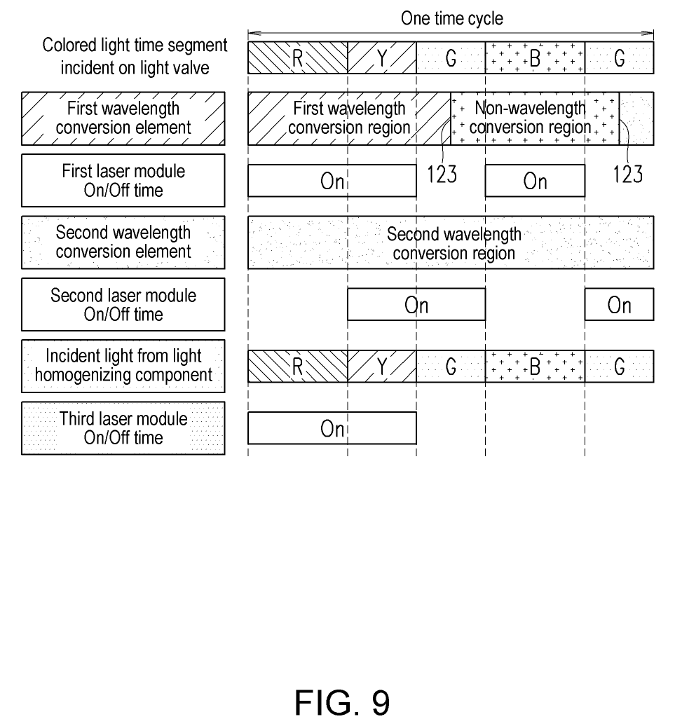

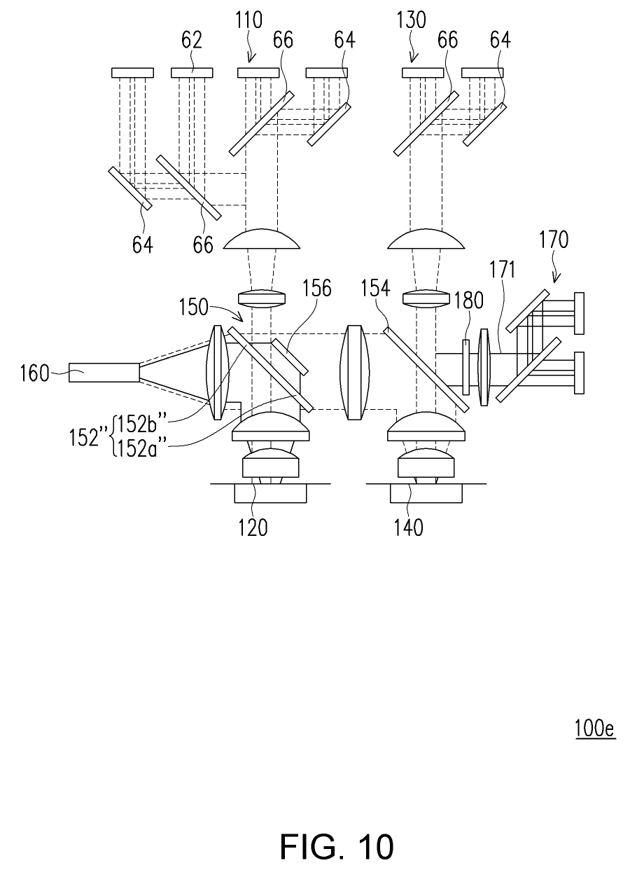

FIGS. 8A,8B, 8C, and 8D are light path diagrams of the illumination system of another embodiment of the disclosure when the first laser beam, the first colored light, the second colored light, and the third colored light are transmitted to the light homogenizing component, respectively, and FIG. 9 is a timing diagram of the projection apparatus adopting the illumination system in FIGS. 8A-8D. Referring to FIGS. 8A-8D and 9, an illumination system 100d of this embodiment is similar to the illumination system 100 in FIGS. 1A-1D, and the main differences between the two systems are described as follows. In the illumination system 100d of this embodiment, the first wavelength conversion region 122 has yellow phosphor, the second wavelength conversion region 142 has green phosphor, and a first dichroic mirror 152' filters the first wavelength-converted beam 121 to provide a red light beam, that is, the first colored light C1 is a red light beam, and the second dichroic mirror 154 filters the second wavelength-converted beam 141 to provide a green light beam, that is, the second colored light C2 is a green light beam. Specifically, a second part 152b' of the first dichroic mirror 152' may reflect red light while allowing light in other wavelength bands to transmit through, the first part 152a' of the first dichroic mirror 152' may reflect red light, allow a part (for example, 50%) of blue light to transmit through, and reflect another part (for example, another 50%) of blue light, and allow light in other wavelength bands to transmit through. The timing schematic diagram of the projection apparatus is illustrated in FIG. 9, in which the colored light time segments incident on the light valve 210 are sequentially the R time segment, Y time segment, G time segment, B time segment, and G time segment within one time cycle. The first laser module 110 is turned on during the R time segment and B time segment; the second laser module 130 and the second wavelength conversion element 140 correspond to the G time segment, and the second laser module 130 corresponding to the G time segment is turned on at the transition period between the R time segment and B time segment. The color of the third laser beam 171 may correspond to the color of the first colored light C1, and the emission period of the third laser beam 171 at least partially overlaps with the turned-on period of the first laser module 110, and FIG. 9 takes as an example that the emission period of the third laser beam 171 partially overlaps with the turned-on period of the first laser module 110, that is, in FIG. 9, the third laser beam 171 is emitted only during the R time segment and Y time segment.

FIG. 10 is a light path diagram of the illumination system of yet another embodiment of the disclosure. Referring to FIG. 10, an illumination system 100e of this embodiment is similar to the illumination system 100 in FIG. 1A, and the main difference between the two systems is that, in the illumination system 100e of this embodiment, the third laser beam 171 emitted by the third laser module 170 is a green light beam, and the emission period of the third laser beam 171 at least partially overlaps with the turned-on period of the first laser module 110. In addition, the third laser beam 171 may transmit through a first dichroic mirror 152", compared to the first colored light C1 reflected by the first dichroic mirror 152" which is green light with a relatively wide spectrum, the third laser beam 171 is green light with a relatively narrow spectrum, and the first dichroic mirror 152" may have a lower reflectance within a narrower wavelength range corresponding to the spectrum of the third laser beam 171, so that the third laser beam 171 may transmit through the first dichroic mirror 152", while the green light wavelength range outside of this narrower wavelength range has high reflectance to reflect the first colored light C1. Specifically, the main wavelength of the third laser beam 171 (that is, green light) emitted by the third laser module 170 is, for example, 525 nanometers. The coating spectrum curve design (spectral coating profile) of the first dichroic mirror 152", the second dichroic mirror 154, and the third dichroic mirror 156 makes the transmission efficiency of the third laser beam 171 (that is, green light) from the third laser module 170 greater than or equal to 90%. In this embodiment, the spectral transmission and reflection range of the second part 152b" of the first dichroic mirror 152" is designed to reflect light in 491 nanometers to 520 nanometers and 530 nanometers to 582 nanometers wavelength bands and allow light in other wavelength bands to transmit through. The reflection spectrum of the first part 152a" of the first dichroic mirror 152" for green light is the same as that of the second part 152b" but reflects a part (such as 50%) of blue light and allows another part (such as another 50%) of blue light to transmit through. In this embodiment, the emission period of the third laser beam 171 is corresponding to the G time segment and Y time segment, or the third laser beam 171 is emitted only during the G time segment.

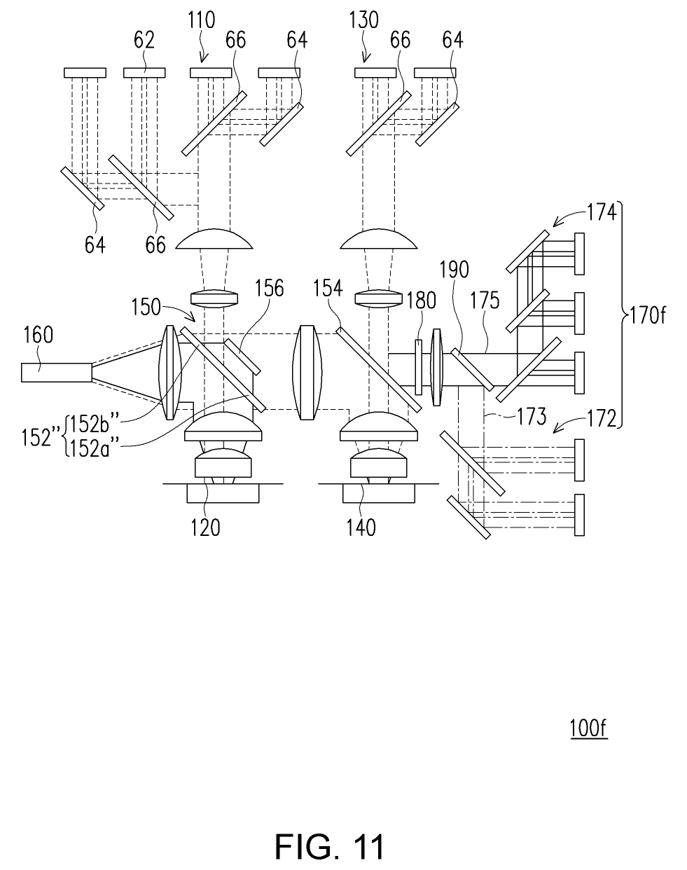

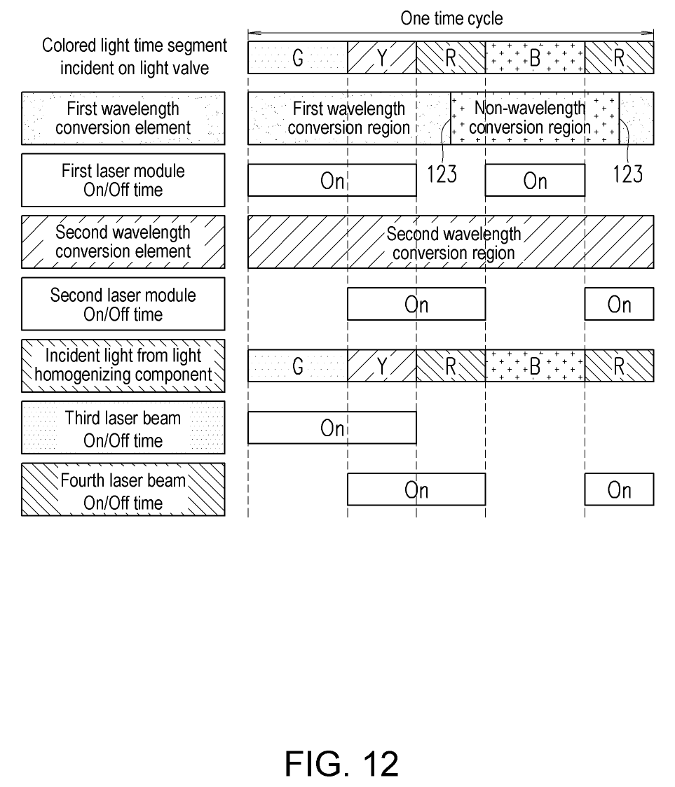

FIG. 11 is a light path diagram of the illumination system of still another embodiment of the disclosure, and FIG. 12 is a timing diagram of light beams of the projection apparatus adopting the illumination system in FIG. 11. Referring to FIGS. 11 and 12, an illumination system 100f of this embodiment is similar to the illumination system 100 in FIG. 1, and the main differences between the two systems are as follows. In the illumination system 100f of this embodiment, a third laser module 170f is configured to provide a third laser beam 173 and a fourth laser beam 175. For example, the third laser module 170f includes a first sub-laser module 172 and a second sub-laser module 174, configured to respectively provide the third laser beam 173 and the fourth laser beam 175. The color of the third laser beam 173 corresponds to the color of the first colored light C1, and the color of the fourth laser beam 175 corresponds to the color of the second colored light C2. In this embodiment, the third laser beam 173 is, for example, a green light beam, and the fourth laser beam 175 is, for example, a red light beam. In this embodiment, the transmittance of the third laser beam 173 through the light guide component 150 is greater than or equal to 90%, and the transmittance of the fourth laser beam 175 through the light guide component 150 is greater than or equal to 90%. In this embodiment, the emission period of the fourth laser beam 175 at least partially overlaps with the turned-on period of the second laser module 130, and the emission period of the third laser beam 173 at least partially overlaps with the turned-on period of the first laser module 110. In this embodiment, the illumination system 100f may include a fourth dichroic mirror 190, which combines (merges) the light paths of the fourth laser beam 175 and the third laser beam 173, for example, the fourth dichroic mirror 190 is configured to reflect green light and is configured to allow red light to transmit through, thereby the light paths of red light and green light may be combined. In this embodiment, the emission period of the fourth laser beam 175 is corresponding to the R time segment and Y time segment, or the fourth laser beam 175 is emitted only during the R time segment.

The diffusion component 180 may be disposed on the light paths of the third laser beam 173 and the fourth laser beam 175, and is located between the third laser module 170f and the light guide component 150, and the diffusion component may be a static element or a movable element.

In summary, the illumination system and the projection apparatus of the embodiments of the disclosure have at least one of advantages as follows. In the embodiments of the disclosure, when an interface between at least one first wavelength conversion region and at least one non-wavelength conversion region of the first wavelength conversion element is disposed on a predetermined light path of the first laser beam, the first laser module is in a turned-off state, and the second laser module is in a turned-on state. In this way, the configuration may prevent the first laser beam from irradiating the interface and generating unstable mixed-colored light. Instead, at this time, the second laser beam provided by the second laser module forms the second colored light by means of the second wavelength conversion element and the light guide component, so that the light valve at this time may be turned on and receive the second colored light. Therefore, by controlling the switching of the laser modules, to increase the switching frequency of the colored light beam received by the light valve per unit time, the illumination system and the projection apparatus of the embodiments of the disclosure may achieve high brightness and good image quality, and may effectively suppress laser speckle phenomenon with the combination of the laser modules and wavelength conversion elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a first laser module configured to emit a first laser beam;
a first wavelength conversion element comprising at least one first wavelength conversion region and at least one non-wavelength conversion region, wherein the at least one first wavelength conversion region and the at least one non-wavelength conversion region are sequentially disposed on a light path of the first laser beam, and the at least one first wavelength conversion region is configured to convert the first laser beam into a first wavelength-converted beam;
a second laser module configured to emit a second laser beam;
a second wavelength conversion element comprising a second wavelength conversion region, wherein the second wavelength conversion region is disposed on a light path of the second laser beam, the second wavelength conversion region is configured to convert the second laser beam into a second wavelength-converted beam, wherein when an interface between the at least one first wavelength conversion region and the at least one non-wavelength conversion region of the first wavelength conversion element being disposed on a predetermined light path of the first laser beam, the first laser module is in a turned-off state, and the second laser module is in a turned-on state; and
a light guide component disposed on light paths of the first wavelength-converted beam from the first wavelength conversion element and the second wavelength-converted beam from the second wavelength conversion element, wherein the light guide component is configured to filter the first wavelength-converted beam to provide a first colored light, and filter the second wavelength-converted beam to provide a second colored light.

2. The illumination system as claimed in claim 1, wherein when a portion of the first wavelength conversion region is disposed on the light path of the first laser beam emitted by the first laser module, both the first laser module and the second laser module are in a turned-on state, so that the first colored light and the second colored light from the light guide component are superposed to form a third colored light.

3. The illumination system as claimed in claim 2, further comprising a light homogenizing component, wherein within a time cycle, the first colored light, the third colored light, the second colored light, the first laser beam, and the second colored light from the light guide component are sequentially transmitted to the light homogenizing component.

4. The illumination system as claimed in claim 1, wherein the light guide component comprises:
a first dichroic mirror disposed between the first laser module and the first wavelength conversion element, and configured to reflect a portion of the first wavelength-converted beam to filter the first wavelength-converted beam to provide the first colored light, and the first colored light is transmitted to a light homogenizing component; and
a second dichroic mirror disposed between the second laser module and the second wavelength conversion element , and configured to reflect a portion of the second wavelength-converted beam to filter the second wavelength-converted beam to provide the second colored light, and the second colored light is transmitted to the light homogenizing component.

5. The illumination system as claimed in claim 4, wherein the light guide component further comprises a third dichroic mirror disposed between the first dichroic mirror and the first laser module, wherein the non-wavelength conversion region of the first wavelength conversion element is configured to reflect the first laser beam to the first dichroic mirror, a portion of the first laser beam is reflected by the first dichroic mirror, and another portion of the first laser beam is transmitted through the first dichroic mirror and is then reflected by the third dichroic mirror.

6. The illumination system as claimed in claim 1, further comprising a third laser module configured to provide at least one of a third laser beam and a fourth laser beam, wherein the light guide component is disposed on a light path of the at least one of the third laser beam and the fourth laser beam, wherein a color of the third laser beam corresponds to a color of the first colored light, and a color of the fourth laser beam corresponds to a color of the second colored light.

7. The illumination system as claimed in claim 6, wherein a transmittance of the third laser beam through the light guide component is greater than or equal to 90%, and a transmittance of the fourth laser beam through the light guide component is greater than or equal to 90%.

8. The illumination system as claimed in claim 6, wherein an emission period of the fourth laser beam at least partially overlaps with a turned-on period of the second laser module.

9. The illumination system as claimed in claim 6, wherein an emission period of the third laser at least partially overlaps with a turned-on period of the first laser module.

10. The illumination system as claimed in claim 6, further comprising a diffusion component disposed on the light path of the at least one of the third laser beam and the fourth laser beam, and located between the third laser module and the light guide component.

11. The illumination system as claimed in claim 10, wherein the diffusion component is a statics element or a movable element.

12. The illumination system as claimed in claim 1, wherein a spectral overlap area of the first colored light and the second colored light is less than 15% of a spectral area of the first colored light or the second colored light.

13. The illumination system as claimed in claim 1, further comprising a third laser module configured to provide a third laser beam, wherein the light guide component is disposed on a light path of the third laser beam, wherein a color of the third laser beam corresponds to a color of the first colored light or the second colored light.

14. The illumination system as claimed in claim 1, wherein an optical characteristic of the first wavelength conversion region of the first wavelength conversion element is same as an optical characteristic of the second wavelength conversion region of the second wavelength conversion element .

15. The illumination system as claimed in claim 1, wherein an optical characteristic of the first wavelength conversion region of the first wavelength conversion element is different from an optical characteristic of the second wavelength conversion region of the second wavelength conversion element .

16. The illumination system as claimed in claim 1, wherein the second wavelength conversion element is a stationary element or a movable element.

17. The illumination system as claimed in claim 1, wherein rotation speeds of the first wavelength conversion element and the second wavelength conversion element are same or different.

18. The illumination system as claimed in claim 1, wherein the first wavelength conversion element and the second wavelength conversion element are located on a same rotating substrate, and a radial distance of the first wavelength conversion element to a central axis of the rotating substrate is not equal to a radial distance of the second wavelength conversion element to the central axis of the rotating substrate.

19. A projection apparatus, comprising:
an illumination system, comprising:
a first laser module configured to emit a first laser beam;
a first wavelength conversion element comprising at least one first wavelength conversion region and at least one non-wavelength conversion region, wherein the at least one first wavelength conversion region and the at least one non-wavelength conversion region are timing-sequentially disposed on a light path of the first laser beam, and the at least one first wavelength conversion region is configured to convert the first laser beam into a first wavelength-converted beam;
a second laser module configured to emit a second laser beam;
a second wavelength conversion element comprising a second wavelength conversion region, wherein the second wavelength conversion region is disposed on a light path of the second laser beam, the second wavelength conversion region is configured to convert the second laser beam into a second wavelength-converted beam, wherein when an interface between the at least one first wavelength conversion region and the at least one non-wavelength conversion region of the first wavelength conversion element being disposed on a predetermined light path of the first laser beam, the first laser module is in a turned-off state, and the second laser module is in a turned-on state; and
a light guide component disposed on light paths of the first wavelength-converted beam from the first wavelength conversion element and the second wavelength-converted beam from the second wavelength conversion element , wherein the light guide component is configured to filter the first wavelength-converted beam to provide a first colored light, and filter the second wavelength-converted beam to provide a second colored light;
a light valve disposed on a light path of an illumination beam, and configured to convert the illumination beam into an image beam, wherein the illumination beam comprises at least one of the first colored light, the second colored light, and the first laser beam; and
a projection lens disposed on a light path of the image beam, and configured to project the image beam out of the projection apparatus.
